(19) United States
(12) Patent Application Publication
(10) Pub. No.: US 2003/0108375 A1
(43) Pub. Date: Jun. 12, 2003

(54) Partial keyboard cover having character inscriptions

(76) Inventors: Claudia D. Nichol, Agoura Hills, CA (US); Sandra B. Brazier, Agoura Hills, CA (US); Deidra B. Jeffries, Valencia, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/013,894

(22) Filed: Dec. 7, 2001

(51) Int. Cl. B41J 5/08

(52) U.S. Cl. 400/490

(57) ABSTRACT

A partial keyboard cover includes a resiliently flexible transparent body overlying a predetermined number of non-format and non-function keys, i.e., alpha-numeric keys of a keyboard. A wall extends downwardly from a perimeter of the body so as to at least partially envelope the keys, and grooves are formed within the body so that the body individually form-fits the non-format and non-function keys covered by the body. Character inscriptions, such as foreign language symbols, are formed on the top surface of the body over the keys of the keyboard and offset from imprinted indicia on the keys so as to enable the simultaneous viewing of the key character and the body character inscriptions.

### BACKGROUND OF THE INVENTION

The present invention generally relates to computer keyboard covers. More particularly, the present invention relates to a partial computer keyboard cover useable on a variety of different keyboards and having character inscriptions to enable the simultaneously viewing of the inscriptions and the underlying key characters.

Historically, there have been available opaque keyboard covers used to teach the skill of typing and keyboarding, and which assist students in memorizing the locations of keyboard letters and symbols. Other keyboard covers are transparent and are primarily used to protect the keyboard from contaminants and the like. Almost without exception, such keyboard cover designs cover the entire top, four vertical sides, and underside edges of a flat or standard keyboard frame, and are designed to form-fit each letter, number, format and function key of the keyboard array. Current covers use grooves and rows molded to form-fit the four sides of all keys.

However, the display of keyboards vary from device to device. For example, the “enter” key may be rectangular in shape on certain keyboards, and a backwards “L” shape in others. Other format keys including the “caps lock”, “shift”, “control”, “alt”, “space bar”, “tab”, and “backspace” keys also vary from keyboard to keyboard. Although function keys typically are aligned along a top portion of the keyboard, the relative size and position of these keys can vary from keyboard to keyboard. Directional arrow or cursor keys, defined for purposes in this application as those keys having arrows thereon capable of moving the cursor up, down or side to side, as well as the “insert”, “home”, “page up”, “delete”, “end” and “page down” also vary in size and position from keyboard to keyboard. Although many keyboards include a 10-key pad, which is often fairly universal in nature, this cluster of keys is spaced from the other clusters to differing degrees from keyboard to keyboard.

Due to the fact that there are over 3,000 different keyboard models, each with different function and format key sizes and spacing between them, depending upon the brand/model of the keyboard, there are over 3,000 corresponding keyboard covers which are either opaque or transparent.

When purchasing, to assure proper fit of a prior-art keyboard cover, the consumer was required to order the cover by brand name and model or serial number, a lengthy and time-consuming process. Additionally, a keyboard cover order was typically manufactured as a low-volume custom order as high-volume manufacturing techniques could not be used, rendering the keyboard covers expensive to manufacture and purchase. In fact, some companies manufacturing such custom covers based on brand name/model number variations discontinued manufacturing these covers due to the fact that the demand was insufficient to merit the maintaining of production capabilities.

A school of thought exists which maintains that the use of Dvorak keyboard arrangement increases efficiency and work product. Most, if not all, operating system keyboard preference options include a Dvorak keyboard layout choice. However, the Dvorak keyboard layout cannot be readily used without removing and changing all of the individual key caps to convert from one keyboard configuration to another.

Many computer operating systems offer the option of changing the user's language of choice to any one of sixty or more language options. Many of these foreign language keyboard options require a different keyboard layout. If the user did not have the differences memorized to use the language option chosen, each key would have to be individually capped, or replaced, with the new language characters, an inconvenient and time-consuming process. Some foreign language options do not require the physical keyboard layout to be changed. However, the user must still have the corresponding key characters memorized.

The inventors of the present application discovered, as disclosed in U.S. Pat. No. 6,050,825, the contents of which are hereby incorporated by reference, that when the function and format keys were omitted from the keyboard cover design, and only the three or four alpha-numeric rows are covered, then the keyboard cover shape becomes uniform and universal for flat and ergonomic keyboards. This is due to the fact that these three or four rows of alpha-numeric-punctuation keys are the same size and configuration on nearly all models/brands of computer keyboards. Such a partial keyboard cover allowed the high-volume manufacturing of opaque covers intended for keyboard memorization.

The '825 patent discloses printing foreign characters and the like onto an opaque keyboard cover so that when another keyboard layout, or foreign language, is selected, the partial keyboard cover can be placed over the alphanumeric-punctuation keys instead of having to cap or replace the keys of the keyboard, or have the foreign language characters and layout memorized. Although the opaque cover disclosed in the '825 patent greatly improved upon prior keyboard covers, particularly in the keyboard memorization field, there have been found to be certain disadvantages with using such an opaque cover. For example, an American businessman having a meeting in Brazil may wish to have the option of typing either in Portuguese or English without having to remove the keyboard cover as the businessman may be working on multiple documents simultaneously, or the document may include sentences or paragraphs in either language. It has been found that in a religious setting, for example, a Jewish scholar may desire to have access to both the Hebrew keyboard layout and character inscriptions and the English keys simultaneously. If the businessman or scholar does not have the layout memorized, he is left with the undesirable option of repetitively covering and uncovering the keyboard with the opaque, imprinted Nopper et al. device.

Accordingly, there is a need for a partial transparent computer keyboard cover which can universally fit most computer keyboards, and which includes character inscriptions over the covered keys to enable the simultaneous viewing of the character inscription and the underlying key character. The present invention fulfills these needs and provides other related advantages.

### SUMMARY OF THE INVENTION

The present invention resides in a cover for a partial section of a keyboard having a frame and multiple alpha-numeric, function and format keys. The partial keyboard cover generally comprises a resiliently flexible transparent body which overlies a predetermined number of non-format and non-function keys totaling less than all the keys of the keyboard. A wall extends downwardly from a perimeter of the body so as to at least partially envelope peripheral keys of the predetermined number of non-format and non-function keys. Grooves are formed within the body and configured such that the body individually form-fits the non-format and non-function keys. Typically, the body overlies all alphabetical keys of the keyboard. Preferably, the body further overlies numerical and punctuation keys of the keyboard, the alphabetical, numerical and punctuation keys being referred to in this application collectively as alphanumeric keys.

The body removably rests on the predetermined keys of the keyboard. Atop surface of the body may include home-row indication protrusions to enable the proper placement of the user's fingers. Preferably, the body includes a midline marking which defines a separation line for adapting the cover to an ergonomic keyboard having a separation between two set of keys. The mid-line marking may be embossed imprinted to facilitate the separation of the body for such ergonomic keyboards.

Character inscriptions are formed on a top surface of the body over predetermined covered keys of the keyboard and offset from imprinted indicia on each underlying key so as to enable the simultaneously viewing of the key character and the body character. The character inscriptions can include foreign language alphabetical or numerical symbols, Braille character symbols, Dvorak keyboard symbols, etc.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a exploded view of a keyboard assembly and a cover embodying the present invention;

FIG. 2 is a perspective view of the cover placed over alphanumeric keys of the keyboard assembly, illustrating the simultaneous viewing of character inscriptions formed on the cover and key characters of the keyboard assembly; and

FIG. 3 is a cross-sectional view taken generally along line 3-3 of FIG. 2, illustrating the form-fitting nature of the cover of the present invention.

### DETAILED DESCRIPTION OF THE PREFERRED EMBODIMENT

As shown in the drawings for purposes of illustration, the present invention is concerned with a partial keyboard cover, generally referred to in the drawings by the reference number 10. The cover 10 is designed to overlie a partial section of a keyboard assembly 12 so as to be universal in nature and applied to any commercially available keyboard assembly 12.

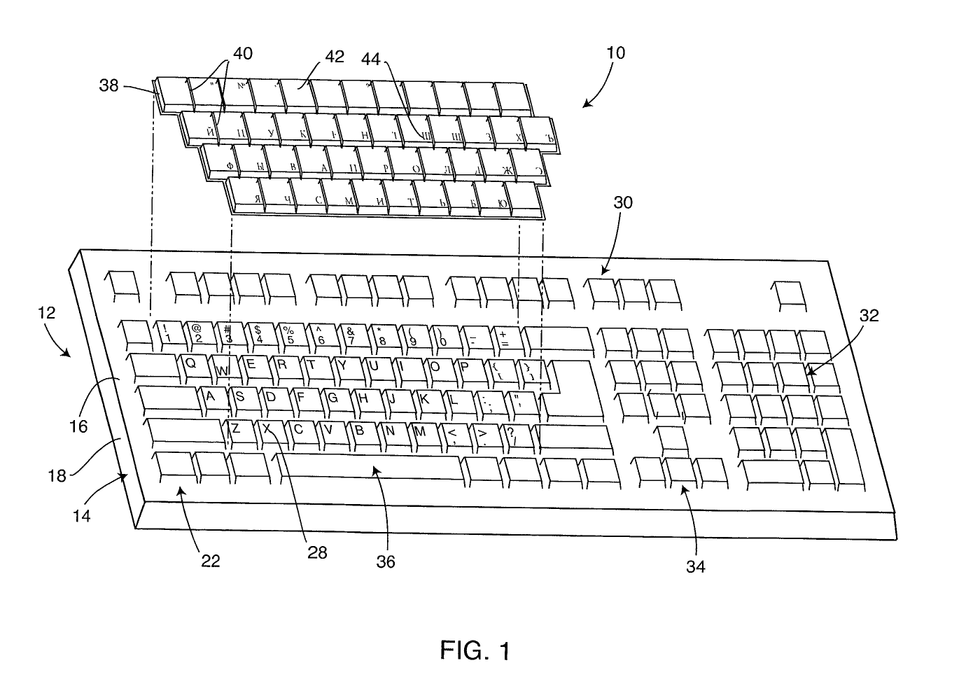

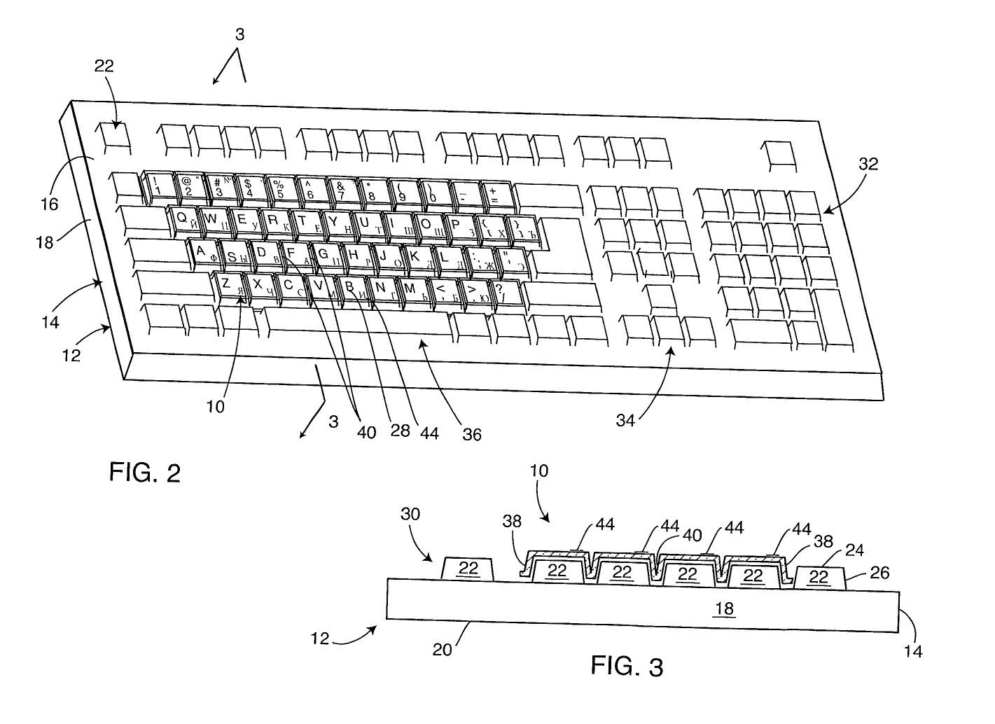

Keyboard assemblies 12 are well known in the art and have become an integral part of many machines including word processing devices and computers. Such keyboard assemblies 12 include a rigid frame 14 defining a top deck 16, side walls 18, and a rear or obverse face of the keyboard assembly 12. The keyboard assembly 12 also includes a plurality of keys 22 which are generally formed into rows and columns having a predetermined configuration and collectively forming a two-dimensional array. Each key 22 of the array extends through the deck 16 of the frame 16 and by depression operate, either electronically or mechanically, through intervening means (not shown), so as to generate a signal to the device with which the keyboard assembly 12 is associated. The various keys 22 may be of varying size, but all keys 22 generally include a relatively planar top surface 24 and side walls 26 which extend from the top surface toward the deck 16. The side walls 26 generally have a small degree of taper, as illustrated in the drawings. With reference to FIG. 1, each key 22 includes identifying indicia imprinted thereon according to the keyboard layout. In the accompanying drawings, only the key characters 28 of non-format, non-function keys are illustrated as only these keys 22 are relevant to the present invention.

With continuing reference to FIG. 1, the key array can actually be divided into a number of key clusters. For example, a top row of keys 22 comprising the “escape”, “functions 1-12”, “print screen”, “scroll”, “pause break”, and in certain models “number lock”, “caps lock”, and “scroll lock” are aligned with one another and form what is referred to collectively in this application as a function-key cluster 30. The spacing between the keys 22 of the function-key cluster 30 varies from keyboard assembly manufacturer, with some manufacturers including the number lock, caps lock or scroll lock keys, while others not including these raised keys.

Most commercially available keyboard assemblies 12 also include a 10-key cluster 32 comprising a “numbers lock”, “/”, “*”, “−”, “7”, “8”, “9”, “+”, “4”, “5”, “6”, “1”, “2”, “3”, “0”, “.”, and “enter” keys 22.

Most commercially available keyboard assemblies 12 also include what is referred to in this application as a cursor-key cluster 34 comprising the “insert”, “home”, “page up”, “delete”, “end”, “page down”, and directional arrow or cursor keys.

Each commercially available keyboard assembly 12 also includes what is referred to in this application as an alpha-numeric and format/command key cluster 36 comprising the alphabetical, numeric, punctuation and symbols (including “−”, “_”, “+”, “=”, “{”, “[”, “}”, “]”, “:”, “;”, ““”, “””, “<”, “,”, “>”, “.”, “?”, “/”), “back space”, “tab”, “caps lock”, “enter”, “right and left shift”, “control”, “alt”, “space bar” and “˜/'” keys. Different manufacturers may place additional keys within the alpha-numeric and format/command key cluster 36 which are specific in use to the keyboard assembly 12 and machine to which it is operably connected. These unique keys are typically placed on either side of the “space bar key”. Thus, the “space bar key” can be of varying lengths depending upon the keyboard assembly 12 type.

The partial keyboard cover 10 of the present invention is comprised of a one-piece resiliently flexible membrane, such as polyurethane, plastic or rubber material, which is transparent ortranslucent so as to enable a user of the cover 10 to view the keys 22 and their respective key characters 28 through the cover 10. The cover 10 is manufactured using conventional thermo-forming, vacuum molding, or any other suitable method of molding and formation.

The partial cover, or body, 10 includes a wall 38 extending vertically downwardly from a perimeter of the body 10 so as to at least partially, and preferably fully, envelope peripheral keys of the alphabetical, numeric, and punctuation and symbol keys comprising what is known in the art as the four alpha-numeric rows. Grooves 40 are formed within the body in order to create multiple bubbles or casings 42 which are configured to overlap and form-fit their respective alpha-numeric keys 22. Thus, the cover 10 individually form-fits the predetermined number of non-format and non-function keys comprising the four alpha-numeric rows of the keyboard assembly 12. Regardless of the keyboard assembly 12 type, the four rows of alpha-numeric keys are of the same size and configuration. Thus, no matter the model or brand of the keyboard assembly 12, the keys 22 of the alpha-numeric rows can be substantially form-fitted by the cover 10. It will be noted that the “backspace” key, “˜−'”, “enter”, “tab”, “shift”, “Ctrl”, “Alt”, “space bar”, and other formatting and command keys are not form-fitted as these keys vary in size, configuration, and placement between the various keyboard assemblies 12.

The partial cover 10 preferably also includes home-row indicator protrusions (not shown) to assist the typist in indicating the home-row keys, typically the “F” and “J” keys 22. As many keyboard assemblies 12 are ergonomic in nature, that is the alpha-numeric and function/command key section 36 is split, the cover 10 preferably also includes a mid-line marking which is either imprinted or embossed to allow the cover to be separated into pieces to fit the split ergonomic keyboard assembly 12.

If one closely examines the alpha-numeric keys 22 of any given keyboard assembly 12, it will be noted that the keyboard characters 28 are imprinted on the keys 22 to the far left, or upper left hand corner of the top surface of the key 24, leaving a portion of the top surface 24 blank or devoid of any imprinting. The present invention takes advantage of this blank area by imprinting character inscriptions 44 on a top surface of the cover 10 on the far right or lower right-hand corner of each relevant bubble or casing 42 so that as the cover 10 is placed on the four alpha-numeric rows, the character inscriptions do not obstruct the key characters, enabling both to be viewed simultaneously.

A Russian (Cyrillic) character inscription layout is imprinted, or otherwise formed, on the cover 10. It will be noted that some of the bubbles/casings 42 do not include character inscriptions as there is not a difference between the keyboard character layout and the Russian (Cyrillic) layout for that particular key 22. The Russian (Cyrillic) character inscription layout is provided as an example and it will be understood that other foreign language character inscriptions, such as Hebrew, Portuguese, etc., can be imprinted according to their particular keyboard layout onto the cover 10. Also, non-foreign language character layouts, such as Dvorak, QWERTY, etc., can be formed or printed on the cover 10 as well. Moreover, the character inscriptions 44 may comprise symbols, such as Braille symbols or the like. The object of the present invention is to provide a keyboard layout according to the user's needs onto the partial section cover 10 which is useable on virtually all keyboard assemblies 12.

Using the cover 10 of the present invention allows one to simultaneously view the character layout of the keyboard assembly 12 and the character inscriptions 44 imprinted onto the cover 10. This prevents the burdensome repetitive removal and placement of the opaque Nichol et al partial cover, as described above. The present invention allows one who does not have both layouts memorized to work between documents, or utilize the different layouts in an easy manner. Due to the fact that the cover 10 only encompasses the four alpha-numeric rows, the cover 10 is universal in use.

Although several embodiments of the present invention have been described in detail for purposes of illustration, various modifications of each may be made without departing from the spirit and scope of the invention. Accordingly, the invention is not to be limited, except as by the appended claims.

What is claimed is:

1. A cover for a partial section of a keyboard having a frame and multiple alpha-numeric, function and format keys, the cover comprising:
a resiliently flexible transparent body which overlies a predetermined number of non-format and non-function keys totaling less than all of the keys of the keyboard;
a wall extending downwardly from a perimeter of the body so as to at least partially envelop peripheral keys of the predetermined number of non-format and non-function keys;
grooves within the body and configured so that the body individually form-fits the predetermined number of non-format and non-function keys; and
character inscriptions formed on a top surface of the body over predetermined covered keys of the keyboard and offset from imprinted indicia on the covered keys so as to enable the simultaneous viewing of the key character and body character inscription.

2. The cover of claim 1, wherein the body overlies all alphabetical keys of the keyboard.

3. The cover of claim 2, wherein the body further overlies numerical keys of the keyboard.

4. The cover of claim 2, wherein the body further overlies punctuation keys of the keyboard.

5. The cover of claim 2, wherein the character inscriptions comprise foreign language alphabetical symbols.

6. The cover of claim 2, wherein the character inscriptions comprise Braille alphabetical character symbols.

7. The cover of claim 2, wherein the character inscriptions comprise Dvorak keyboard symbols.

8. The cover of claim 3, wherein the character inscriptions comprise foreign language numeric symbols.

9. The cover of claim 3, wherein the character inscriptions comprise Braille numeric character symbols.

10. The cover of claim 1, including a mid-line marking which defines a separation line for adapting the cover to an ergonomic keyboard having a separation between two sets of keys.

11. The cover of claim 10, wherein the mid-line marking is embossed or imprinted.

12. The cover of claim 1, wherein the body removably rests on the predetermined keys of the keyboard.

13. The cover of claim 1, wherein a top surface of the body includes home-row indication protrusions.

14. A cover for a partial section of a keyboard having a frame and multiple alpha-numeric, function and format keys, the cover comprising:
a resiliently flexible transparent body removably placed over a predetermined number of non-format and non-function keys, including all alphanumeric keys, totaling less than all of the keys of the keyboard;
a wall extending downwardly from a perimeter of the body so as to at least partially envelop peripheral keys of the predetermined number of non-format and non-function keys;
grooves within the body and configured so that the body individually form-fits the predetermined number of non-format and non-function keys; and
character inscriptions formed on a top surface of the body over predetermined covered keys of the keyboard and offset from imprinted indicia on the covered keys so as to enable the simultaneous viewing of the key character and body character inscription.

15. The cover of claim 14, wherein the character inscriptions comprise foreign language alphabetical, punctuation, and numeric symbols.

16. The cover of claim 14, wherein the character inscriptions comprise Braille alphabetical, numeric and punctuation character symbols.

17. The cover of claim 14, wherein the character inscriptions comprise Dvorak keyboard symbols.

18. The cover of claim 14, including a mid-line marking which defines a separation line for adapting the cover to an ergonomic keyboard having a separation between two sets of keys.

19. The cover of claim 14, wherein a top surface of the body includes home-row indication protrusions.

20. A cover for a partial section of a keyboard having a frame and multiple alpha-numeric, function and format keys, the cover comprising:
a resiliently flexible transparent body removably placed over a predetermined number of non-format and non-function keys, including all alphanumeric keys, totaling less than all of the keys of the keyboard;
a wall extending downwardly from a perimeter of the body so as to at least partially envelop peripheral keys of the predetermined number of non-format and non-function keys;
grooves within the body and configured so that the body individually form-fits the predetermined number of non-format and non-function keys;
character inscriptions formed on a top surface of the body over predetermined covered keys of the keyboard and offset from imprinted indicia on the covered keys so as to enable the simultaneous viewing of the key character and body character inscription;
a mid-line marking which defines a separation line for adapting the cover to an ergonomic keyboard having a separation between two sets of keys; and
home-row indication protrusions extending from the top surface of the body.

21. The cover of claim 20, wherein the character inscriptions comprise foreign language alphabetical, punctuation and numeric symbols.

22. The cover of claim 20, wherein the character inscriptions comprise Braille alphabetical, punctuation and numeric character symbols.

23. The cover of claim 20, wherein the character inscriptions comprise Dvorak keyboard symbols.
